(19) United States
(12) Patent Application Publication
(10) Pub. No.: US 2002/0081425 A1
(43) Pub. Date: Jun. 27, 2002

(54) Anti-forgery sticker and its manufacturing method

(76) Inventor: Kwang-Gil Oh, Seoul (KR)

Correspondence Address: SCHMEISER OLSEN & WATTS, 18 E UNIVERSITY DRIVE, SUITE # 101, MESA, AZ, 85201

(21) Appl. No.: 09/775,175

(22) Filed: Feb. 1, 2001

(30) Foreign Application Priority Data
Dec. 26, 2000 (KR) 2000-82101

(51) Int. Cl. B32B 31/00

(52) U.S. Cl. 428/343; 428/323; 428/916; 156/60

(57) ABSTRACT

Disclosed are an anti-forgery sticker and its manufacturing method which are capable of preventing a forgery by comparing a particular pattern, generated when particles are added to and pressed against the inside of a sticker, with an image stored in a memory, and ascertaining whether or not the particles exist in the inside of the sticker.

The anti-forgery sticker includes an original sticker designed suitable for a product with the sticker attached thereto, an identification number printed on the original sticker for being compared with the scanned image of the sticker, fixed particles attached to and pressed against the original sticker for displaying an identifiable pattern, and a transparent sheet coating the original sticker having the particles attached thereto for fixing the particles and preventing any damage.

The anti-forgery sticker according to the present invention has an advantage of preventing the product from being forged since it is capable of judging whether or not the product is authentic by comparing the sticker with the image stored in the memory and ascertaining whether or not the particles exist in the inside of the sticker.

### BACKGROUND OF THE INVENTION

1. Field of the Invention

The present invention generally relates to an anti-forgery sticker and its manufacturing method, and more particularly, to an anti-forgery sticker and its manufacturing method, which are capable of judging whether or not a product is authentic by comparing a particular pattern made when particles are added to and pressed against the inside of a sticker with an image stored in a memory, and ascertaining whether or not the particles exist in the inside of the sticker.

2. Description of the Related Art

In general, a silver-colored line or a hologram is used to prevent gift certificates or other products from being illegally reproduced. With the latest development of illegal reproduction technique, such conventional ways as the silvercolored line or hologram are no longer safe from the illegal reproduction. Therefore, current attempts have been directed toward developing a sticker which is capable of preventing the illegal reproduction as well as allowing the public to easily judge whether or not a product is authentic. The sticker meeting users' demand, however, does not exist at least up till now.

### SUMMARY OF THE INVENTION

It is, therefore, an object of the present invention to provide an anti-forgery sticker and its manufacturing method, which are capable of judging whether or not a product is authentic by arranging and attaching particles to the inside of a sticker, coating and pressing the sticker with a transparent sheet, attaching the sticker to the product, first comparing the sticker with an image stored in a memory, and then ascertaining whether or not the particles exist in the inside of the sticker.

To achieve the above object, the present invention provides an anti-forgery sticker and its manufacturing method, the manufacturing method comprising the steps of printing a sticker with an identification number thereon, attaching an adequate number of particles to the printed sticker, and coating and pressing the sticker with a transparent sheet.

It is desirable that the transparent sheet is made of one of synthetic resins, such as cellophane paper, polyethylene, polypropylene, polyvinyl, and the likes. A bond or an adhesive is generally used with the synthetic resin so as for the sticker to have an adhesive property.

The anti-forgery sticker comprises an original sticker designed suitable for a product on which the sticker is to be attached, an identification number printed on the original sticker for being compared with the scanned shape of the sticker, fixed particles attached to and pressed against the original sticker for displaying an identifiable pattern, and a transparent sheet coating the original sticker against which the particles are pressed, for fixing the pressed particles and preventing a damage.

The method for manufacturing then anti-forgery sticker according to the present invention will be described herein below.

The sticker is designed and an identification number is printed on the sticker. Here, necessary particulars, including a domain address of a company over Internet, can be simultaneously printed with the identification number. An adequate number of particles are attached to the sticker having the identification number, which is then coated with a transparent sheet and pressed under proper pressure. The sticker manufactured in this manner has a particular pattern depending on arrangement of the particles and the pressure applied to the particles.

The use of the sticker manufactured in the aforementioned manner will be described herein below.

The sticker is scanned and the scanned image of the sticker is stored in a memory. Here, the memory is either a CDROM or a database server connected to a web server. Then, the sticker manufactured in the above manner is attached to a product.

If a consumer wants to ascertain whether or not the product is authentic, the consumer compares the scanned image of the original sticker, which is stored in the memory, with the sticker and the identification number printed in the sticker attached to the product. That is, the consumer compares the image, which is generated when the identification number printed in the sticker is inputted after the CDROM having scanned the sticker is executed in case of purchase of the product, with the sticker through off-line. Or, the consumer compares the image, which is generated in a web browser after the identification number printed in the sticker is inputted in a web site providing the scanned image of the sticker, with the sticker through on-line. Once the consumer judges that the sticker and the image provided by the memory are identical to each other, the coating of transparent sheet on the sticker attached to the product is stripped off a little bit to ascertain whether or not the particles exist inside the sticker. If the particles are kept in the same shapes as pressed earlier, the product may be judged to be authentic. Briefly, the authenticity of the product is judged through two courses of comparing the sticker with the image stored in the memory and ascertaining whether or not the particles really exist.

### BRIEF DESCRIPTION OF THE DRAWINGS

The above and other objects, features and advantages of the present invention will become more apparent from the following detailed description when taken in conjunction with the accompanying drawings, in which:

FIG. 1a is a diagram illustrating a sticker printing step in a process of manufacturing an anti-forgery sticker according to the present invention;

FIG. 1b is a diagram illustrating a particle attaching step in the process of manufacturing the anti-forger sticker according to the present invention; and

FIG. 1c is a diagram illustrating a coating and pressing step in the process of manufacturing the anti-forgery sticker according to the present invention.

### DETAILED DESCRIPTION OF THE PREFERRED EMBODIMENT

Preferred embodiments of the present invention will be described herein below with reference to the accompanying drawings. In the following description, well-known functions or constructions are not described in detail since they would obscure the invention in unnecessary detail.

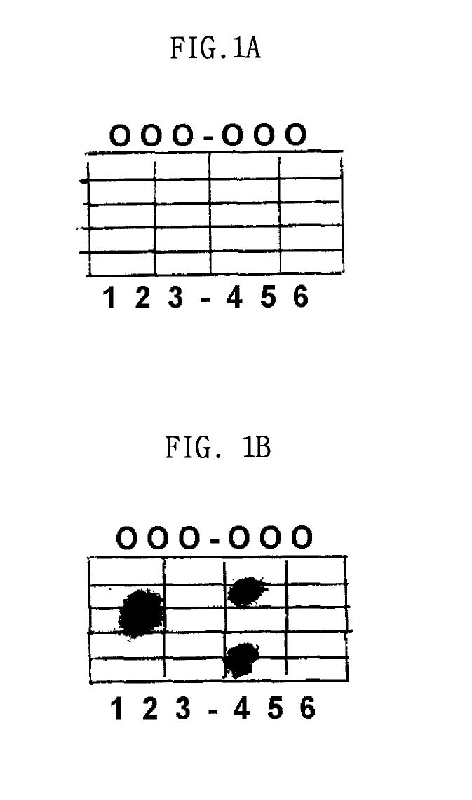

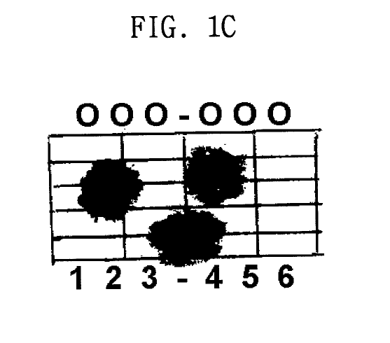

FIG. 1a to FIG. 1c are diagrams illustrating a process of manufacturing an anti-forgery sticker.

FIG. 1a is a diagram illustrating a sticker printing step in the process of manufacturing the anti-forgery sticker.

A sticker is made to have size, shape and quality of paper suitable for a product and properly designed for the product. An identification number for one sticker is printed on the corresponding sticker. If necessary, additional facts, including a domain address of a company, may be also printed on the sticker.

FIG. 1b is a diagram illustrating a particle attaching step in the process of manufacturing the anti-forgery sticker.

An adequate number of particles are attached to the printed sticker. The particles may be substances which are formed by irregularly cutting a solid body into small pieces, i.e., bits of feather, pieces of thread, etc. In addition, grains of crayon generated when a prescribed shape is drawn on the sticker by means of a crayon or the likes may be employed as the particles.

FIG. 1c is a diagram illustrating a coating and pressing step in the process of manufacturing the anti-forgery sticker.

The sticker with the particles attached thereto is coated with a transparent sheet. The coated sticker is pressed under proper pressure, so that the particles can be closely adhered to the sticker, thereby not being moved. The pressing enables the particles to be so pressed against the inside of the sticker that an identifiable pattern can be generated.

Through the steps shown in FIG. 1a to FIG. 1c , the anti-forgery sticker is manufactured.

As stated above, the anti-forgery sticker according to the present invention has an advantage of preventing the product from being forged since it is capable of judging whether or not the product is authentic by comparing the sticker with the image stored in the memory and ascertaining whether or not the particles exist in the inside of the sticker.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for manufacturing an anti-forgery sticker, the method comprising the steps of:
printing a sticker with an identification number thereon;
attaching an adequate number of particles to said printed sticker; and
coating and pressing said sticker with a transparent sheet.

2. The method of claim 1, wherein said particles are one of bits of feather, pieces of thread, and grains of crayon.

3. The method of claim 1, wherein said transparent sheet is made of one of cellophane paper, polyethylene, polypropylene, and polyvinyl.

4. An anti-forgery sticker capable of judging whether or not a product is authentic by means of a scanned image of a sticker stored in a memory and particles attached to the inside of said sticker, the anti-forgery sticker comprising:
an original sticker properly designed to be suitable for a product with said sticker attached thereto;
an identification number printed on said original sticker for being compared with said scanned image of said sticker;
fixed particles attached to and pressed against said original sticker for displaying an identifiable pattern; and
a transparent sheet coating said original sticker having said particles attached thereto for fixing said particles and preventing any damage.

5. The anti-forgery sticker of claim 4, wherein said scanned image of said sticker stored in said memory is searched with said identification number.

6. The anti-forgery sticker of claim 5, wherein said memory is ether a CDROM or a database connected to a web server.

7. The anti-forgery sticker of claim 4, wherein said particles are one of bits of feather, pieces of thread, and grains of crayon.

8. The anti-forgery sticker of claim 4, wherein said transparent sheet is made of one of cellophane paper, polyethylene, polypropylene, and polyvinyl.
